(19) United States
(12) Patent Application Publication
(10) Pub. No.: US 2024/0165990 A1
(43) Pub. Date: May 23, 2024

(54) DYNAMIC VEHICLE WHEEL BALANCE APPARATUS, VEHICLE WHEEL, POWERED VEHICLE, AND METHOD FOR MANUFACTURE THEREOF

(71) Applicant: HOWMET AEROSPACE INC., Pittsburgh, PA (US)

(72) Inventors: Douglas P. MASON, Livonia, MI (US); Dieter JÜLING, Kelkheim (DE); Tobias KUNISCHEWSKI, Frankfurt am Main (DE)

(21) Appl. No.: 18/551,543

(22) PCT Filed: Mar. 25, 2021
(86) PCT No.: PCT/US2021/024074

§ 371 Date: Sep. 20, 2023

(51) Int. Cl. B60B 7/04; B60B 7/06; B60B 7/08; B60B 21/12

(52) U.S. Cl. CPC B60B 7/04; B60B 7/061; B60B 7/08; B60B 21/12; B60B 2320/30; B60B 2900/1216

(57) ABSTRACT

A dynamic vehicle wheel balance apparatus, a vehicle wheel, a powered vehicle, and a related method for manufacture are provided. The dynamic vehicle wheel balance apparatus comprises a vehicle wheel cover and a dynamic vehicle wheel balance ring. The vehicle wheel cover comprises a first surface, a second surface, and a perimeter surface connecting the first surface to the second surface. The vehicle wheel cover is configured to removably attach to a flange of a vehicle wheel with the second surface opposing the vehicle wheel. The dynamic vehicle wheel balance ring is attached to the second surface of the vehicle wheel cover. The dynamic vehicle wheel balance apparatus dynamically balances the vehicle wheel during rotation of the vehicle wheel and reduces aerodynamic drag.

### FIELD OF USE

The present disclosure relates to a dynamic vehicle wheel balance apparatus, a vehicle wheel, a powered vehicle, and a related method for manufacture.

### BACKGROUND

Vehicle wheels comprising undesired mass distributions can cause vibrations and/or reduce fuel mileage during operation of a wheeled vehicle. Additionally, the mass of the vehicle wheels can affect the fuel mileage of the vehicle. Balancing a vehicle wheel's mass and achieving desirable vehicle fuel mileage present challenges.

### SUMMARY

According to one aspect of the present disclosure, a dynamic vehicle wheel balance apparatus is provided. The dynamic vehicle wheel balance apparatus comprises a vehicle wheel cover and a dynamic vehicle wheel balance ring. The vehicle wheel cover comprises a first surface, a second surface, and a perimeter surface connecting the first surface to the second surface. The vehicle wheel cover is configured to removably attach to a flange of a vehicle wheel with the second surface opposing the vehicle wheel. The dynamic vehicle wheel balance ring is attached to the second surface of the vehicle wheel cover.

According to another aspect of the present disclosure, a vehicle wheel is provided. The vehicle wheel is connected to a dynamic vehicle wheel balance apparatus. The dynamic vehicle wheel balance apparatus comprises a vehicle wheel cover and a dynamic vehicle wheel balance ring. The vehicle wheel cover comprises a first surface, a second surface, and a perimeter surface connecting the first surface to the second surface. The vehicle wheel cover is configured to removably attach to a flange of a vehicle wheel with the second surface opposing the vehicle wheel. The dynamic vehicle wheel balance ring is attached to the second surface of the vehicle wheel cover. The dynamic vehicle wheel balance apparatus dynamically balances the vehicle wheel during rotation of the vehicle wheel and reduces aerodynamic drag.

According to another aspect of the present disclosure, a powered vehicle is provided. The powered vehicle wheel comprises a dynamic vehicle wheel balance apparatus installed on a vehicle wheel of the powered vehicle. The dynamic vehicle wheel balance apparatus comprises a vehicle wheel cover and a dynamic vehicle wheel balance ring. The vehicle wheel cover comprises a first surface, a second surface, and a perimeter surface connecting the first surface to the second surface. The vehicle wheel cover is configured to removably attach to a flange of the vehicle wheel with the second surface opposing the vehicle wheel. The dynamic vehicle wheel balance ring is attached to the second surface of the vehicle wheel cover. The dynamic vehicle wheel balance apparatus dynamically balances the vehicle wheel of the powered vehicle during rotation of the vehicle wheel of the powered vehicle and reduces aerodynamic drag of the powered vehicle resulting in an increased fuel savings of the powered vehicle.

According to yet another aspect of the present disclosure, a method for manufacture is provided. The method comprises operatively coupling a snap ring of a dynamic vehicle wheel balance apparatus to a vehicle wheel, wherein clips of the dynamic vehicle wheel balance apparatus are pinned between the snap ring and a flange of the vehicle wheel. The dynamic vehicle wheel balance apparatus comprises a vehicle wheel cover, a dynamic vehicle wheel balance ring, a snap ring, and at least two clips. The vehicle wheel cover comprises a first surface, a second surface, and a perimeter surface connecting the first surface to the second surface. The vehicle wheel cover is configured to removably attach to the flange of the vehicle wheel with the second surface opposing the vehicle wheel. The dynamic vehicle wheel balance ring is attached to the second surface of the vehicle wheel cover. The vehicle wheel cover defines at least two first openings proximal to the perimeter surface. Each of the at least two first openings extends from the first surface to the second surface and is configured to receive a fastener to operatively couple the vehicle wheel cover to the flange of a vehicle wheel. The snap ring is configured to operatively couple to the flange of the vehicle wheel. Each clip comprises a first portion configured to mount to the snap ring and a second portion comprising a bore configured to be aligned with one of the first openings and receive a respective fastener and thereby connect the clip to the vehicle wheel cover. The method comprises operatively coupling the vehicle wheel cover to the clips utilizing fasteners.

It is understood that the inventions disclosed and described in this specification are not limited to the aspects summarized in this Summary. The reader will appreciate the foregoing details, as well as others, upon considering the following detailed description of various non-limiting and non-exhaustive aspects according to this specification.

### BRIEF DESCRIPTION OF THE DRAWINGS

The features and advantages of the examples, and the manner of attaining them, will become more apparent, and the examples will be better understood, by reference to the following description taken in conjunction with the accompanying drawings, wherein:

FIG. 1A is a front perspective view of a non-limiting embodiment of a dynamic vehicle wheel balance apparatus according to the present disclosure;

FIG. 1B is a rear plan view of the dynamic vehicle wheel balance apparatus shown in FIG. 1A;

FIG. 2 is an exploded perspective view of a non-limiting embodiment of a dynamic vehicle wheel balance apparatus according to the present disclosure, also showing a vehicle wheel on which the apparatus can be installed;

FIG. 3 is a cross sectional view of the dynamic wheel balance apparatus and wheel shown in FIG. 2;

FIG. 4A is a detail view of a portion of a non-limiting embodiment of a dynamic wheel balance apparatus according to the present disclosure shown installed on the vehicle wheel;

FIG. 4B is a cross-sectional detail view of the non-limiting embodiment of a dynamic wheel balance apparatus according to FIG. 4A shown installed on the vehicle wheel;

FIG. 5A is a detail view of a region of a non-limiting embodiment of a dynamic wheel balance apparatus according to the present disclosure shown installed on a vehicle wheel;

FIG. 5B is a cross-sectional detail view of the dynamic wheel balance apparatus comprising the region shown in FIG. 5A shown installed on the vehicle wheel; and

FIG. 6 is a flow chart illustrating a non-limiting method for coupling a non-limiting embodiment of a dynamic vehicle wheel balance apparatus according to the present disclosure to a vehicle wheel.

Corresponding reference characters indicate corresponding parts throughout the several views. The exemplifications set out herein illustrate certain embodiments, in one form, and such exemplifications are not to be construed as limiting the scope of the appended claims in any manner.

### DETAILED DESCRIPTION

Various embodiments are described and illustrated herein to provide an overall understanding of the structure, function, and use of the disclosed articles and methods. The various embodiments described and illustrated herein are non-limiting and non-exhaustive. Thus, an invention is not limited by the description of the various non-limiting and non-exhaustive embodiments disclosed herein. Rather, the invention is defined solely by the claims. The features and characteristics illustrated and/or described in connection with various embodiments may be combined with the features and characteristics of other embodiments. Such modifications and variations are intended to be included within the scope of this specification. As such, the claims may be amended to recite any features or characteristics expressly or inherently described in, or otherwise expressly or inherently supported by, this specification. Further, Applicant reserves the right to amend the claims to affirmatively disclaim features or characteristics that may be present in the prior art. The various embodiments disclosed and described in this specification can comprise, consist of, or consist essentially of the features and characteristics as variously described herein.

Any references herein to “various embodiments,” “some embodiments,” “one embodiment,” “an embodiment,” or like phrases mean that a particular feature, structure, or characteristic described in connection with the example is included in at least one embodiment. Thus, appearances of the phrases “in various embodiments,” “in some embodiments,” “in one embodiment,” “in an embodiment,” or like phrases in the specification do not necessarily refer to the same embodiment. Furthermore, the particular described features, structures, or characteristics may be combined in any suitable manner in one or more embodiments. Thus, the particular features, structures, or characteristics illustrated or described in connection with one embodiment may be combined, in whole or in part, with the features, structures, or characteristics of one or more other embodiments without limitation. Such modifications and variations are intended to be included within the scope of the present embodiments.

As used herein, a referenced element or region that is “intermediate” two other elements or regions means that the referenced element/region is disposed between, but is not necessarily in contact with, the two other elements/regions. Accordingly, for example, a referenced element that is “intermediate” a first element and a second element may or may not be immediately adjacent to or in contact with the first and/or second elements, and other elements may be disposed between the referenced element and the first and/or second elements.

Typically, aerodynamic covers and wheel balance rings are independently attached to an axle of a powered vehicle and, therefore, require independent removal. A balance ring is typically mounted between two vehicle wheels in a dual wheel arrangement, or between the axle hub and the vehicle wheel in a single wheel arrangement. Attaching additional components to the hub of the vehicle wheel increases the number of interfaces in the clamped joint at the hub, which can increase the potential for joint loosening. Also, attaching both aerodynamic cover and balance ring components to the hub can increase the mass of the vehicle wheel assembly. Since components such as aerodynamic covers and vehicle wheel balance rings are typically attached to the hub of the axle, removing those components may require removing the nuts and/or bolts that attach the vehicle wheel to the hub. The components may have to be individually removed from the axle each time a vehicle wheel is replaced. The apparatus described in WO 2008/023216 A1 and WO 2003/023252A1, for example, may suffer from one or more of the foregoing disadvantages.

The present disclosure provides a dynamic vehicle wheel balance apparatus comprising a vehicle wheel cover and a dynamic vehicle wheel balance ring. The vehicle wheel cover can comprise a first surface, a second surface, and a perimeter surface connecting the first surface to the second surface. The vehicle wheel cover can be adapted to removably attach to a flange of a vehicle wheel with the second surface opposing the vehicle wheel. The dynamic vehicle wheel balance ring can be attached to the second surface of the vehicle wheel cover. Embodiments of the dynamic vehicle wheel balance apparatus according to the present disclosure can: reduce the number of interfaces in the vehicle wheel/axle joint; reduce the mass required to attach a vehicle wheel cover and a vehicle wheel balance ring to the vehicle wheel; enable installation and/or removal of the vehicle wheel to/from an axle of a powered vehicle without the need to remove the dynamic vehicle wheel balance apparatus from the vehicle wheel; and increase fuel efficient and/or battery life of a vehicle that powers the vehicle wheel.

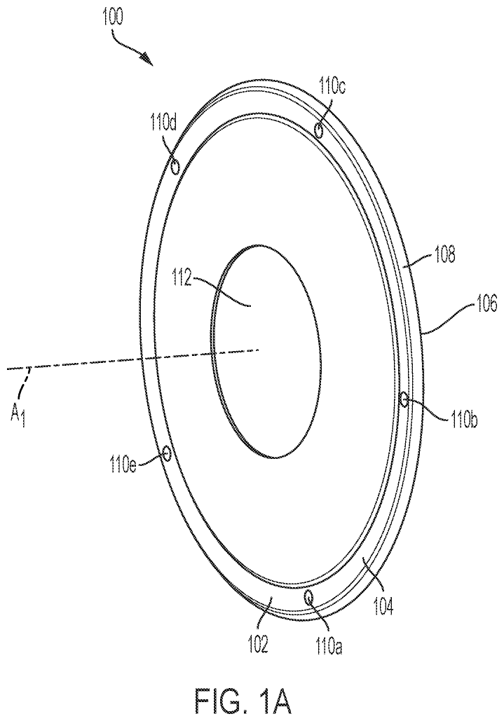

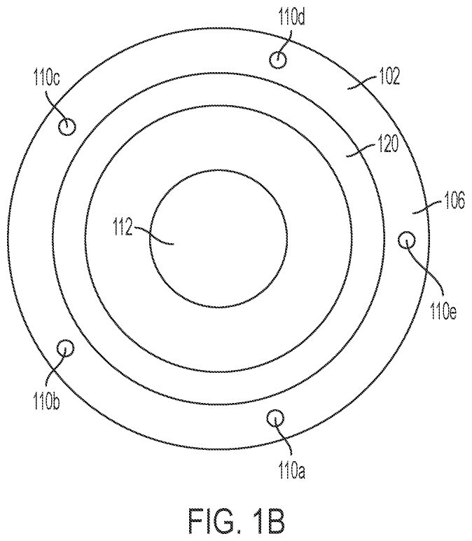

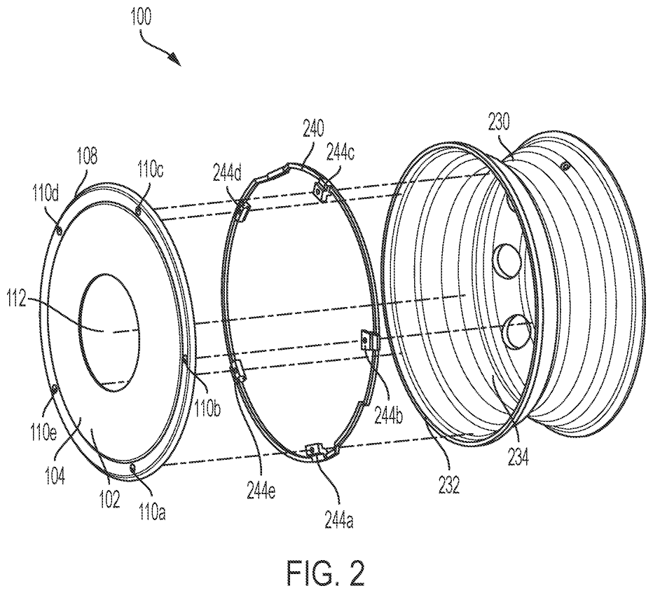

Referring to FIG. 1, a non-limiting embodiment of a dynamic vehicle wheel balance apparatus 100 is provided. The dynamic vehicle wheel balance apparatus 100 can comprise a vehicle wheel cover 102 and a dynamic vehicle wheel balance ring 120. In various non-limiting embodiments in which the dynamic vehicle wheel balance apparatus 100 is connected to a vehicle wheel (e.g., vehicle wheel 230 illustrated in FIGS. 2, 3, 4A-B, and 5A-5B), the dynamic vehicle wheel balance apparatus 100 can both dynamically balance the vehicle wheel 230 during rotation of the vehicle wheel and reduce aerodynamic drag of the vehicle wheel 230. The dynamic vehicle wheel balance apparatus 100 can be configured to attach to the vehicle wheel 230 without the need to attach the apparatus 100 to a hub of a powered vehicle. As such, in various non-limiting embodiments, installation of the dynamic vehicle wheel balance apparatus 100 on the vehicle wheel 230 can occur prior to mounting the vehicle wheel 230 to the hub and/or the vehicle wheel 230 can be removed from the hub while the dynamic vehicle wheel balance apparatus 100 is attached to the vehicle wheel 230.

Referring again to FIGS. 1A-1B, the vehicle wheel cover 102 can comprise a first surface 104, a second surface 106, and a perimeter surface 108 connecting the first surface 104 to the second surface 106. The vehicle wheel cover 102 can be adapted to removably attach to a flange of a vehicle wheel (e.g., flange 232 of vehicle wheel 230 shown in FIG. 2) in an orientation as shown with the second surface 106 opposing the vehicle wheel. The first surface 104 of the vehicle wheel cover 102 can be configured to reduce aerodynamic drag of the vehicle wheel to which the vehicle wheel cover 102 is operably connected.

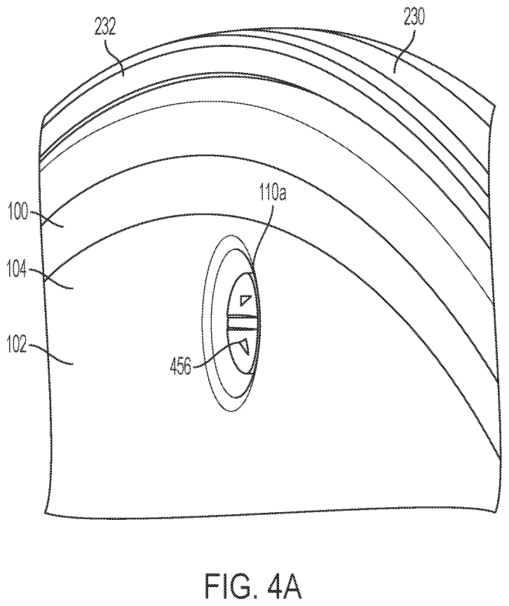

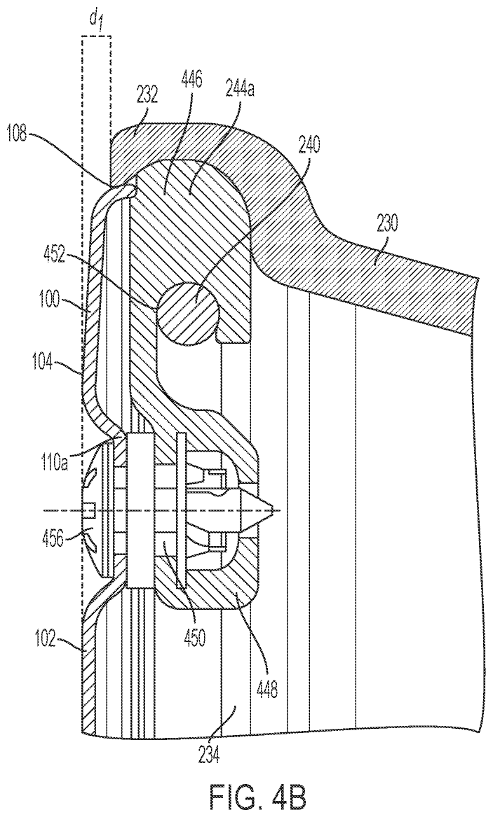

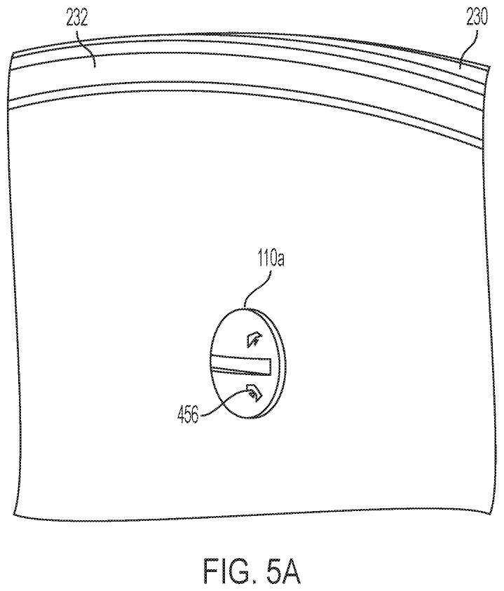

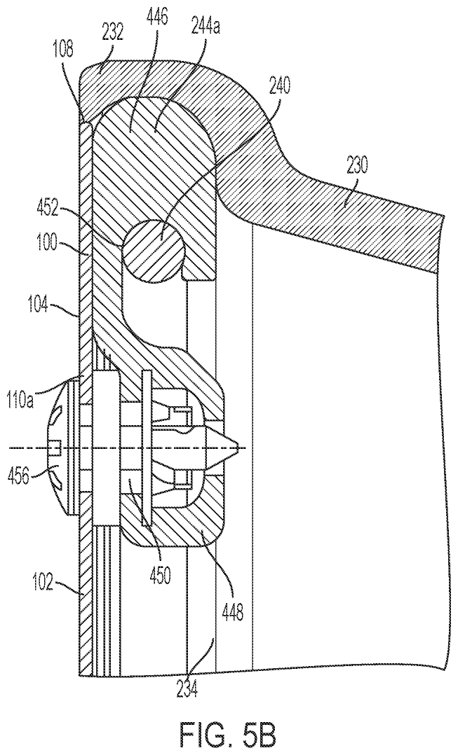

The vehicle wheel cover 102 can define at least two first openings proximal to the perimeter surface 108, such as first openings 110a, 110b, 110c, 110d, and 110e as shown in FIGS. 1A-1B. In various non-limiting embodiments, first openings 110a-e are located intermediate the dynamic vehicle wheel balance ring 120 and the perimeter surface 108. The first openings 110a-110e can extend from the first surface 104 to the second surface 106, and each first opening 110a-110e can be configured to receive a fastener to operatively couple the vehicle wheel cover 102 to the flange 232 of the vehicle wheel 230 (e.g., as shown and described with respect to FIGS. 4A-4B and 5A-5B). In various non-limiting embodiments, at least one of the first openings 110a-e can be counter sunk. For example, FIGS. 4A-4B depict first opening 110a as countersunk. In various non-limiting embodiments, at least one of the first openings 110a-e is not counter sunk and the first surface 102 can be substantially planar such that the head of a fastener extends beyond the first surface 102. For example, FIGS. 5A-5B depicts first opening 110a as not counter sunk.

Referring again to the rear plan view of FIG. 1B, the dynamic vehicle wheel balance ring 120 can be connected to the second surface 106 of the vehicle wheel cover 102. For example, the dynamic vehicle wheel balance ring 120 may be structurally integrated with the vehicle wheel cover 102, connected to the vehicle wheel cover 102 with fasteners, and/or bonded to the vehicle wheel cover (e.g., welded, glued). The dynamic vehicle wheel balance ring 120 can be configured to minimize and/or eliminate undesired mass distributions as the wheel to which the balance ring 120 is connected rotates. Mass imbalances in a rotating wheel can result in, for example, wheel vibrations and premature tire wear. In various non-limiting embodiments, the dynamic vehicle wheel balance ring 120 can comprise a circular raceway enclosing a media. The media may comprise at least one of a moveable object, a fluid (e.g., a liquid), or a combination. The moveable object may be, for example, a spheroidal object (e.g., a ball, an ovoid, a generally spherical shape), a cylinder, or another object that is configured to move within the circular raceway in response to moment of the wheel and thereby adjust the mass distribution of the vehicle wheel 230 and reduce imbalance. In particular, when the dynamic wheel balance ring 120 rotates about axis, A₁, the media within the balance ring 120 is subjected to a centrifugal force and is dispersed around the circular raceway in positions that counteract mass imbalances in the rotating vehicle wheel, thereby reducing vibrations in the rotating vehicle wheel.

Referring to FIG. 2, in various non-limiting embodiments, the dynamic vehicle wheel balance apparatus 100 can comprise a snap ring 240 configured to operatively couple to a flange 232 of the vehicle wheel 230. In various embodiments, the flange 232 can have any conventional configuration. For example, the flange 232 of the vehicle wheel 230 can be configured as the flange region of the vehicle wheel described and depicted in International Application No. PCT/US2020/051829, which is hereby incorporated herein by reference in its entirety. The snap ring 240 can directly couple the dynamic vehicle wheel balance apparatus 100 to the vehicle wheel 230 and/or the snap ring 240 can be configured to incorporate additional components, such as, for example, clips, adapted to couple the dynamic vehicle wheel balance apparatus 100 to the vehicle wheel 230. For example, in various non-limiting embodiments, the dynamic vehicle wheel apparatus 100 can comprise at least two clips, such as for example clips 244a, 224b, 244c, 244d, and 244e as shown in FIG. 2, adapted to couple the dynamic vehicle wheel balance apparatus 100 to the vehicle wheel 230.

The configuration of clips 244a-e will now be described with reference to clip 244a, but it is understood that any of clips 244b-e may or may not, also have the features of clip 244a described herein. Referring to FIGS. 4B and 5B, clip 244a can comprise a first portion 446 and a second portion 448. The first portion 446 can be configured to mount to the snap ring 240. For example, the first portion 446 can be substantially J-shaped and configured to be pinned between the snap ring 240 and the flange 232 of the vehicle wheel 230. The first portion 446 can comprise a cavity 452 that is sized to receive the snap ring 240, and in various non-limiting embodiments the snap ring 240 can be press fit into the cavity 452.

The second portion 448 can comprise a bore 450 configured to be aligned with one of the first openings 110a-110e and receive a fastener 456 and thereby connect the clip 244a to the vehicle wheel cover 102. In various non-limiting embodiments, the bore 450 can be threaded, comprise a quick attachment feature, and/or comprise an alternative fastening feature configured to couple to the fastener 456.

In the depicted non-limiting embodiments, the second portion 448 can be positioned offset from the first portion 446. Positioning the second portion 448 offset from the first portion 446 can lessen a distance that the vehicle wheel cover 102 extends from the vehicle wheel 230 when mounted thereto. For example, in various non-limiting embodiments, when the dynamic vehicle wheel balance apparatus 100 is installed on the vehicle wheel 230, the vehicle wheel cover 120 can protrude a distance, d₁, no greater than 10 mm from a flange of the vehicle wheel (as illustrated in FIG. 4B), can be substantially aligned with the flange 232 of the vehicle wheel 230 (as illustrated in FIG. 5B), or can be recessed below the flange 232 of the vehicle wheel 230.

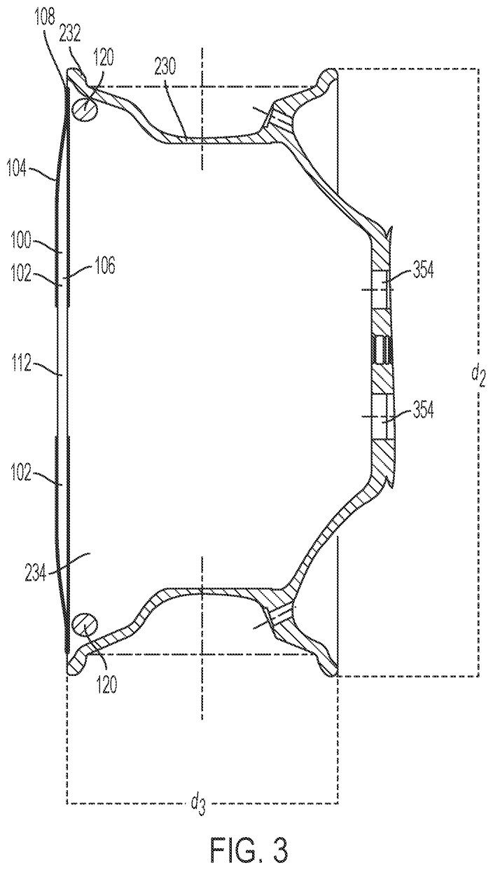

Referring to the non-limiting embodiments illustrated in FIGS. 3, 4B, and 5B, the perimeter surface 108 can be configured to be located within the cavity 234 defined by the flange 232 of the vehicle wheel 230 when the dynamic vehicle wheel balance apparatus 100 is installed on the vehicle wheel 230. That arrangement can reduce aerodynamic drag on the vehicle wheel cover 102. Referring to FIG. 4B, perimeter surface 108 can curve away from the first surface 104 and into the cavity 234. Referring to FIG. 5B, the first surface 104 of the vehicle wheel cover 102 can be substantially planar (e.g., substantially smooth without any surface projections, indentations, or recesses). However, it will be understood that in alternative non-limiting embodiments the first surface 104 can be non-planar, include one or more surface projections, include one or more indentations or recesses, etc.

Referring again to FIGS. 1A-1B, 2, and 3, the vehicle wheel cover 102 defines a second opening 112 extending from the first surface 104 to the second surface 106. In various non-limiting embodiments, each of the first openings 110a-e can be located intermediate the second opening 112 and the perimeter surface 108. As illustrated in FIG. 3, for example, the second opening 112 can be configured to enable access to one or more stud-receiving bores 354 defined in the vehicle wheel 230 when the dynamic vehicle wheel balance apparatus 100 is installed on the vehicle wheel 230. For example, in various embodiments the second opening 112 can be size to enable a lug nut, a lug bolt, other fastener, an operator's hand, a lug wrench, impact driver, or other tool to pass through the second opening 112 and towards stud-receiving bores 354 so that the lug nut and/or lug bolt can be installed on and/or removed from a hub of a powered vehicle while the dynamic vehicle wheel balance apparatus 100 remains installed on the vehicle wheel 230. In various non-limiting embodiments, the second opening 112 is aligned with the stud-receiving bores 354. In certain non-limiting embodiments, the second opening 112 can enable inspection of the vehicle wheel 230 or fastener used to secure the vehicle wheel 230 to the hub of a powered vehicle (e.g., lug nut, lug bolt, other fastener).

Because the dynamic vehicle wheel balance apparatus 100 can be adapted to couple to the flange 232 of the vehicle wheel 100, the first openings 110a-e can be misaligned with the stud-receiving bore 354 defined in the vehicle wheel 230 when the dynamic vehicle wheel balance apparatus 100 is installed on the vehicle wheel 100. In various non-limiting embodiments, the vehicle wheel 230 can comprise a nominal rim diameter, d₂, in a range of 1 inch (2.54 mm) to 200 inches (5080 mm), such as, for example, 14 inches (406.4 mm) to 25 inches (635 mm), or 19 inches (482.6 mm) to 25 inches (635 mm). In various non-limiting embodiments, the vehicle wheel 230 can comprise a nominal rim width, d₃, in a range of 1 inch (2.54 mm) to 100 inches (2540 mm), such as, for example, 6 inches (152.4 mm) to 24 inches (609.6 mm), or 6 inches (152.4 mm) to 12 inches (304.8 mm).

In various non-limiting embodiments, the vehicle wheel balance apparatus 100 can comprise a polymer, a metal, a metal alloy, or a combination of two or more of those materials. In various non-limiting embodiments, the vehicle wheel balance apparatus 100 can comprise rigid materials.

A powered vehicle can comprise the vehicle wheel 230 and the dynamic vehicle wheel balance apparatus 100. During rotation of the vehicle wheel 230 on the powered vehicle, the dynamic vehicle wheel balance apparatus 100 can dynamically balance the vehicle wheel 230 and reduce aerodynamic drag of the powered vehicle, resulting in increased fuel mileage for the powered vehicle. In situations in which the dynamic vehicle wheel balance apparatus of the present invention is mounted on an electrically powered vehicle, the resultant reduced aerodynamic drag that can be achieved with the present invention may increase the distance the vehicle can travel on a single vehicle battery charge.

The powered vehicle can comprise a vehicle weight class in a range of 1 to 8, such as, for example, 3 to 8, as defined by the U.S. Federal Highway Administration. For example, in various non-limiting embodiments the gross weight of the vehicle can be at least 10,001 lbs. (4536.48 kg) or at least 26,000 lbs. (11,798.4 kg). The powered vehicle can be, for example, a light-duty, medium-duty, or heavy-duty vehicle, such as, for example, a medium-duty or heavy-duty vehicle. In various non-limiting embodiments, the powered vehicle can be a truck (e.g., pick-up, full-sized, tractor (e.g., semi-truck)), a van, or a bus. The powered vehicle can comprise at least two axles, such as, for example, at least three axles, at least four axles, at least five axles, or at least six axles. In various non-limiting embodiments, the powered vehicle can comprise no greater than ten axles such as, for example, no greater than six axles, no greater than five axles, no greater than four axles, or no greater than three axles. In various non-limiting embodiments, the powered vehicle can comprise a quantity of axles in a range of two to ten. In various non-limiting embodiments, the powered vehicle can be powered by a combustion engine, one or more electric batteries, or a combination thereof.

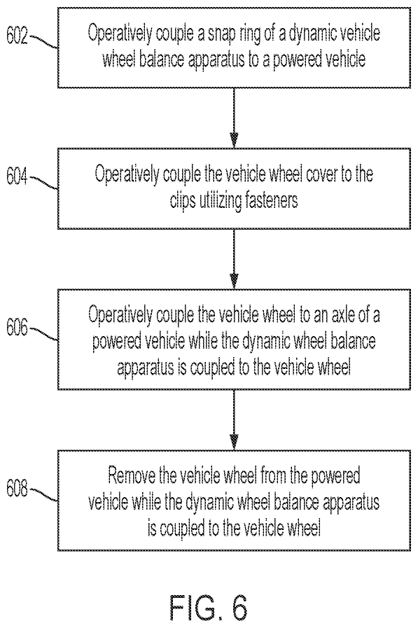

Referring to FIG. 6, a method for coupling the dynamic vehicle wheel balance apparatus 100 to the vehicle wheel 230 is provided. At step 602, the method comprises operatively coupling the snap ring 240 of the dynamic vehicle wheel balance apparatus 100 to the vehicle wheel 230, wherein the clips 244a-e are pinned between the snap ring 240 and the flange 232 of the vehicle wheel 230. For example, the clips 244a-e can be press fit onto the snap ring 240, and the snap ring 240 can be configured with a first diameter suitable to be received by the cavity 234 of the vehicle wheel 230. Thereafter, the snap ring 240 can be inserted into the cavity 234 of the vehicle wheel 230 and then configured with a second diameter such that the snap ring 240 presses the clips 244a-e against the flange 232 of the vehicle wheel 230, thereby securing the clips 244a-e and the snap ring 240 to the vehicle wheel 230. In various non-limiting embodiments, the snap ring 240 can be inserted into the cavity 234 of the vehicle wheel 230 prior to installation of a tire on the vehicle wheel 210 or after installation of a tire on the vehicle wheel 230.

At step 604, the vehicle wheel cover 102 can be operatively coupled to clips 244a-e utilizing fasteners 456. For example, a fastener 456 can be inserted through each of the first openings 110a-e and into the bores 450 of the clips 244a-e. The fasteners 456 can be secured to each of clips 244a-e by rotating the fasteners 456. For example, in various non-limiting embodiments where the bores 450 comprises threads, the fasteners 456 can be screws and can be threaded into the bores 450. In certain non-limiting embodiments in which the bores 450 comprise a quick attachment feature, the fasteners 456 can comprise a quick attachment feature fastener and can be secured to the bores 450 by rotating the fasteners 456. For example, in various embodiments where a quick attachment feature is used, the fasteners 456 can be secured to the bores 450 by rotating each fastener 456 no more than 180 degrees of rotation.

At step 606, the vehicle wheel 230 can be attached to an axle of a powered vehicle while the dynamic vehicle wheel balance apparatus 100 is coupled to the vehicle wheel 230. The axle may be, for example, a steer axle, a drive axle, or a trailer axle of the powered vehicle. Attaching the vehicle wheel 230 can comprise aligning the bores 354 with the lug bolts on a hub of the axle of the powered vehicle and inserting the lug bolts into the bores 354. Thereafter, lug nuts can be inserted through the second opening 112 of the dynamic vehicle wheel balance apparatus 100 and threaded onto the lug bolts, thereby securing the vehicle wheel 230 to the axle.

At optional step 608, the vehicle wheel 230 can be removed from the axle of the powered vehicle while the dynamic vehicle wheel balance apparatus 100 remains coupled to the vehicle wheel 230. In various non-limiting embodiments, the dynamic vehicle wheel balance apparatus 100 can be removed from the vehicle wheel 230 prior to attaching the vehicle wheel 230 to the axle and/or prior to removing the vehicle wheel 230 from the axle. In various non-limiting embodiments, the vehicle wheel 230 can be attached to the axle prior to mounting the dynamic wheel balance apparatus 100.

Various aspects of the invention include, but are not limited to, the aspects listed in the following numbered clauses.
1. A dynamic vehicle wheel balance apparatus comprising:
   a vehicle wheel cover comprising a first surface, a second surface, and a perimeter surface connecting the first surface to the second surface, wherein the vehicle wheel cover is configured to removably attach to a flange of a vehicle wheel with the second surface opposing the vehicle wheel; and
   a dynamic vehicle wheel balance ring attached to the second surface of the vehicle wheel cover.
2. The dynamic vehicle wheel balance apparatus of clause 1, wherein the vehicle wheel cover defines at least two first openings proximal to the perimeter surface, wherein each of the at least two first openings extends from the first surface to the second surface and is configured to receive a fastener to operatively couple the vehicle wheel cover to the flange of a vehicle wheel.
3. The dynamic vehicle wheel balance apparatus of clause 2, further comprising:
   a snap ring configured to operatively couple to the flange of the vehicle wheel; and
   at least two clips, each clip comprising a first portion configured to mount to the snap ring and a second portion comprising a bore configured to be aligned with one of the first openings and receive a respective fastener and thereby connect the clip to the vehicle wheel cover.
4. The dynamic vehicle wheel balance apparatus of clause 3, wherein the second portion is positioned offset from the first portion.
5. The dynamic vehicle wheel balance apparatus of any of clauses 3-4, wherein the first portion is substantially J-shaped and is configured to be pinned between the snap ring and the flange of the vehicle wheel.
6. The dynamic vehicle wheel balance apparatus of any of clauses 2-5, wherein at least one of the at least two first openings is counter sunk.
7. The dynamic vehicle wheel balance apparatus of any of clauses 2-6, wherein the vehicle wheel cover defines a second opening extending from the first surface to the second surface, wherein each of the first openings is located intermediate the second opening and the perimeter surface, and wherein the second opening is configured to enable access to a stud-receiving bore defined in the vehicle wheel when the dynamic vehicle wheel balance apparatus is installed on the vehicle wheel.
8. The dynamic vehicle wheel balance apparatus of clause 7, wherein each of the at least two first openings is misaligned with a stud-receiving bore defined in a vehicle wheel when the dynamic vehicle wheel balance apparatus is installed on the vehicle wheel.
9. The dynamic vehicle wheel balance apparatus of any of clauses 1-8, wherein the first surface of the vehicle wheel cover is substantially flat.
10. The dynamic vehicle wheel balance apparatus of any of clauses 1-9, wherein the perimeter surface curves away from the first surface.
11. The dynamic vehicle wheel balance apparatus of any of clauses 1-10, wherein the perimeter surface is configured to be located within a cavity defined by the flange of the vehicle wheel when the dynamic vehicle wheel balance apparatus is installed on the vehicle wheel.
12. The dynamic vehicle wheel balance apparatus of any of clauses 1-11, wherein when the dynamic vehicle wheel balance apparatus is installed on the vehicle wheel, the vehicle wheel cover protrudes no greater than 10 mm from a flange of the vehicle wheel, is substantially aligned with the flange of the vehicle wheel, or is recessed below the flange of the vehicle wheel.
13. The dynamic vehicle wheel balance apparatus of any of clauses 1-12, wherein the first surface of the vehicle wheel cover is configured to reduce aerodynamic drag of the vehicle wheel.
14. The dynamic vehicle wheel balance apparatus of any of clauses 1-13, wherein the dynamic vehicle wheel balance ring comprises a circular raceway enclosing media.
15. The dynamic vehicle wheel balance apparatus of any of clauses 1-14, wherein each of the at least two first openings are located intermediate the dynamic vehicle wheel balance ring and the perimeter surface.
16. A vehicle wheel having connected thereto the dynamic vehicle wheel balance apparatus of any of clauses 1-15, wherein the dynamic vehicle wheel balance apparatus dynamically balances the vehicle wheel during rotation of the vehicle wheel and reduces aerodynamic drag.
17. The vehicle wheel of clause 16, wherein the vehicle wheel comprises a nominal rim diameter in a range of 1 inch to 200 inches and a nominal rim width in a range of 1 inch to 100 inches.
18. A powered vehicle comprising the dynamic vehicle wheel balance apparatus of any of clauses 1-15 installed on a vehicle wheel of the powered vehicle or the vehicle wheel of any of clauses 16-17 installed on the powered vehicle, wherein the dynamic vehicle wheel balance apparatus dynamically balances the vehicle wheel of the powered vehicle during rotation of the vehicle wheel of the powered vehicle and reduces aerodynamic drag of the powered vehicle resulting in an increased fuel savings of the powered vehicle.
19. A method comprising:
   operatively coupling the snap ring of the dynamic vehicle wheel balance apparatus of any of clauses 3-5 to the vehicle wheel, wherein the clips are pinned between the snap ring and the flange of the vehicle wheel; and
   operatively coupling the vehicle wheel cover to the clips utilizing fasteners.
20. The method of clause 19, further comprising attaching the vehicle wheel to an axle of a powered vehicle while the dynamic vehicle wheel balance apparatus is coupled to the vehicle wheel.

In this specification, unless otherwise indicated, all numerical parameters are to be understood as being prefaced and modified in all instances by the term “about,” in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described herein should at least be construed in light of the number of reported significant digits and by applying ordinary rounding techniques.

Also, any numerical range recited herein includes all sub-ranges subsumed within the recited range. For example, a range of “1 to 10” includes all sub-ranges between (and including) the recited minimum value of 1 and the recited maximum value of 10, that is, having a minimum value equal to or greater than 1 and a maximum value equal to or less than 10. Also, all ranges recited herein are inclusive of the end points of the recited ranges. For example, a range of “1 to 10” includes the end points 1 and 10. Any maximum numerical limitation recited in this specification is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited. All such ranges are inherently described in this specification.

The grammatical articles “a,” “an,” and “the,” as used herein, are intended to include “at least one” or “one or more,” unless otherwise indicated, even if “at least one” or “one or more” is expressly used in certain instances. Thus, the foregoing grammatical articles are used herein to refer to one or more than one (i.e., to “at least one”) of the particular identified elements. Further, the use of a singular noun includes the plural and the use of a plural noun includes the singular, unless the context of the usage requires otherwise.

One skilled in the art will recognize that the herein described articles and methods, and the discussion accompanying them, are used as examples for the sake of conceptual clarity and that various configuration modifications are contemplated. Consequently, as used herein, the specific examples/embodiments set forth and the accompanying discussion are intended to be representative of their more general classes. In general, use of any specific exemplar is intended to be representative of its class, and the non-inclusion of specific components, devices, operations/actions, and objects should not be taken to be limiting. While the present disclosure provides descriptions of various specific aspects for the purpose of illustrating various aspects of the present disclosure and/or its potential applications, it is understood that variations and modifications will occur to those skilled in the art. Accordingly, the invention or inventions described herein should be understood to be at least as broad as they are claimed and not as more narrowly defined by particular illustrative aspects provided herein.

What is claimed is:

1. A dynamic vehicle wheel balance apparatus comprising:
a vehicle wheel cover comprising a first surface, a second surface, and a perimeter surface connecting the first surface to the second surface, wherein the vehicle wheel cover is configured to removably attach to a flange of a vehicle wheel with the second surface opposing the vehicle wheel; and
a dynamic vehicle wheel balance ring attached to the second surface of the vehicle wheel cover, wherein the dynamic vehicle wheel balance ring comprises a circular raceway enclosing media.

2. The dynamic vehicle wheel balance apparatus of claim 1, wherein the vehicle wheel cover defines at least two first openings proximal to the perimeter surface, wherein each of the at least two first openings extends from the first surface to the second surface and is configured to receive a fastener to operatively couple the vehicle wheel cover to the flange of a vehicle wheel.

3. The dynamic vehicle wheel balance apparatus of claim 2, further comprising:
a snap ring configured to operatively couple to the flange of the vehicle wheel; and
at least two clips, each clip comprising a first portion configured to mount to the snap ring and a second portion comprising a bore configured to be aligned with one of the first openings and receive a respective fastener and thereby connect the clip to the vehicle wheel cover.

4. The dynamic vehicle wheel balance apparatus of claim 3, wherein the second portion is positioned offset from the first portion.

5. The dynamic vehicle wheel balance apparatus of claim 3, wherein the first portion is substantially J-shaped and is configured to be pinned between the snap ring and the flange of the vehicle wheel.

6. The dynamic vehicle wheel balance apparatus of claim 2, wherein at least one of the at least two first openings is counter sunk.

7. The dynamic vehicle wheel balance apparatus of claim 2, wherein the vehicle wheel cover defines a second opening extending from the first surface to the second surface, wherein each of the first openings is located intermediate the second opening and the perimeter surface, and wherein the second opening is configured to enable access to a stud-receiving bore defined in the vehicle wheel when the dynamic vehicle wheel balance apparatus is installed on the vehicle wheel.

8. The dynamic vehicle wheel balance apparatus of claim 7, wherein each of the at least two first openings is misaligned with a stud-receiving bore defined in a vehicle wheel when the dynamic vehicle wheel balance apparatus is installed on the vehicle wheel.

9. The dynamic vehicle wheel balance apparatus of claim 1, wherein the first surface of the vehicle wheel cover is substantially flat.

10. The dynamic vehicle wheel balance apparatus of claim 1, wherein the perimeter surface curves away from the first surface.

11. The dynamic vehicle wheel balance apparatus of claim 1, wherein the perimeter surface is configured to be located within a cavity defined by the flange of the vehicle wheel when the dynamic vehicle wheel balance apparatus is installed on the vehicle wheel.

12. The dynamic vehicle wheel balance apparatus of claim 1, wherein when the dynamic vehicle wheel balance apparatus is installed on the vehicle wheel, the vehicle wheel cover protrudes no greater than 10 mm from a flange of the vehicle wheel, is substantially aligned with the flange of the vehicle wheel, or is recessed below the flange of the vehicle wheel.

13. The dynamic vehicle wheel balance apparatus of claim 1, wherein the first surface of the vehicle wheel cover is configured to reduce aerodynamic drag of the vehicle wheel.

14. (canceled)

15. The dynamic vehicle wheel balance apparatus of claim 1, wherein each of the at least two first openings are located intermediate the dynamic vehicle wheel balance ring and the perimeter surface.

16. A vehicle wheel having connected thereto the dynamic vehicle wheel balance apparatus of claim 1, wherein the dynamic vehicle wheel balance apparatus dynamically balances the vehicle wheel during rotation of the vehicle wheel and reduces aerodynamic drag.

17. The vehicle wheel of claim 16, wherein the vehicle wheel comprises a nominal rim diameter in a range of 1 inch to 200 inches and a nominal rim width in a range of 1 inch to 100 inches.

18. A powered vehicle comprising the dynamic vehicle wheel balance apparatus of claim 1 installed on a vehicle wheel of the powered vehicle, wherein the dynamic vehicle wheel balance apparatus dynamically balances the vehicle wheel of the powered vehicle during rotation of the vehicle wheel of the powered vehicle and reduces aerodynamic drag of the powered vehicle resulting in an increased fuel savings of the powered vehicle.

19. A method comprising:
operatively coupling the snap ring of the dynamic vehicle wheel balance apparatus of claim 3 to the vehicle wheel, wherein the clips are pinned between the snap ring and the flange of the vehicle wheel; and
operatively coupling the vehicle wheel cover to the clips utilizing fasteners.

20. The method of claim 19, further comprising attaching the vehicle wheel to an axle of a powered vehicle while the dynamic vehicle wheel balance apparatus is coupled to the vehicle wheel.

21. A dynamic vehicle wheel balance apparatus comprising:
a vehicle wheel cover comprising a first surface, a second surface, and a perimeter surface connecting the first surface to the second surface, wherein the vehicle wheel cover is configured to removably attach to a flange of a vehicle wheel with the second surface opposing the vehicle wheel, wherein the vehicle wheel cover defines at least two first openings proximal to the perimeter surface, wherein each of the at least two first openings extends from the first surface to the second surface and is configured to receive a fastener to operatively couple the vehicle wheel cover to the flange of a vehicle wheel;
a dynamic vehicle wheel balance ring attached to the second surface of the vehicle wheel cover;
a snap ring configured to operatively couple to the flange of the vehicle wheel; and
at least two clips, each clip comprising a first portion configured to mount to the snap ring and a second portion comprising a bore configured to be aligned with one of the first openings and receive a respective fastener and thereby connect the clip to the vehicle wheel cover.
